(19) United States
(12) Patent Application Publication
(10) Pub. No.: US 2017/0024140 A1
(43) Pub. Date: Jan. 26, 2017

(54) STORAGE SYSTEM AND METHOD FOR METADATA MANAGEMENT IN NON-VOLATILE MEMORY

(71) Applicant: Samsung Electronics Co., Ltd., Suwon-si (KR)

(72) Inventors: Srikanth Tumkur Shivanand, Tumkur (IN); Akshay MATHUR, Haryana (IN); Praveen KUMAR, Bihar (IN)

(21) Appl. No.: 15/214,085

(22) Filed: Jul. 19, 2016

(30) Foreign Application Priority Data
Jul. 20, 2015 (IN) 3727/CHE/2015

(51) Int. Cl. G06F 3/06

(52) U.S. Cl. CPC G06F 3/064; G06F 3/0604; G06F 3/065; G06F 3/0679

(57) ABSTRACT

Embodiments herein provide a method for metadata storage management. The method includes receiving a write request having a data. Further, the method includes storing the data in a log entry of a first portion of a metadata log in the Non-volatile memory. Further, the method includes returning an acknowledgement to the write request. Further, the method includes copying the log entry to a second portion of the metadata log. Further, the method includes flushing the data from the second portion to a Solid-state drive (SSD).

### CROSS-REFERENCE TO RELATED APPLICATIONS

This application claims priority from India Patent Application No. 3727/CHE/2015, filed on Jul. 20, 2015, and No. 3727/CHE/2015, filed on Jun. 28, 2016, in the Indian Intellectual Property Office, and all the benefits accruing therefrom under 35 U.S.C. 119, the entire contents of which are hereby incorporated herein by reference.

### BACKGROUND

1. Field

The present application relates to data storage system and more particularly related to a storage system and method for metadata management in Non-volatile memory.

2. Description of the Related Art

Solid State Drive (SSD) is a type of memory device in which data blocks are erased prior to being written to it. Erasing the data block involves moving the data blocks from an old memory location to a new memory location. Further, the data blocks present in the old memory location are erased in a single operation. Metadata is a reference frame to the data blocks; the storage system usually maintains the metadata in a cache or Dynamic random access memory (DRAM). However, during high peak workloads, it is undesirable (or not possible) to maintain all the metadata in the cache.

Consider 100 terabyte (TB) of flash array where the metadata and actual data ratio is given by: (metadata: data ratio) is 1:1000 (in actual can vary from 1:500 to 1:1000). This will end up with managing 100 GB metadata for Log Structure Array (LSA). Due to the limited DRAM availability in the storage box of around 100 GB entire metadata cannot be placed in the DRAM effectively. Further, using a high capacity DRAM for the same may not be economical. Also, the use of DRAM may not support Sudden Power-Off Recovery (SPOR).

According to the LSA based storage solution, the data is initially maintained in the non-volatile memory and acknowledges the user write request. Further, the storage system flushes the data stripe in the Non-Volatile memory to the SSD array. The LSA based storage solution may require the following metadata to map the data in the SSD(s):

1) LBA map: LBA→vbid+vaddr (where vbid is the virtual block id of stripe and vaddr is the offset in the stripe)
2) Volume table: (to map volume id to LBA range and corresponding LBA map)
3) Stripe Map Table: (Vbid+Vaddrs)→(pbid+Vaddrs) (Pbid refers to the physical block id).

The SSD with negative-AND (NAND) flash components move data among those components at the granularity of a page (e.g., 4 kilobytes) and then only to previously erase pages. Typically, the pages are erased exclusively in blocks of 64 or more pages (i.e., 256 KB or more). Accordingly, to store data from one or more input/output (I/O) requests, e.g., smaller than the page, the SSD may modify the page; the entire block (e.g., 256 KB) is erased followed by the rewriting of the entire block as modified by the data (i.e., less than a page, 8 KB). As a result, storing the data to the SSD may be slow and inefficient, even slower than some traditional magnetic media disk drives. Further, frequent accessing of the metadata from the SSD may degrade the system performance and can affect the overall I/O performance. Thus, fast and efficient acknowledgement of the I/O requests by the storage system is desirable so as to reduce latency from the perspective of a host. There exists a method where some protocols permit data to be stored out-of-order, i.e., in different order to that which I/O requests from the host are received at the storage system.

However, data associated with the I/O request may be lost when power is interrupted on the storage system. This is particularly problematic when the I/O request, e.g., a write request from the host has been acknowledged by the storage system. Further, the write data associated with the request has been sent to the one or more storage devices prior to a power loss e.g., logging the write request (including write data) to a persistent medium on the storage system and acknowledging the write request to the host reduces the window of storage system vulnerability, i.e., the time during which the storage system cannot guarantee persistent storing of the write request to the data container.

The above information is presented as background information only to help the reader to understand present inventive concepts. Applicants have made no determination and make no assertion as to whether any of the above might be applicable as Prior Art with regard to the present application.

### SUMMARY

The principal object of the embodiments herein is to provide a storage system and a method for metadata management in a Non-volatile memory.

Another object of the embodiments herein provides a Non-volatile memory including a metadata log divided into a first portion and a second portion.

Another object of the embodiments herein provides a processor, coupled to the Non-volatile memory, configured to receive a write request having a data.

Yet another object of the embodiments herein provides a processor configured to store the data in a log entry of a first portion of a metadata log in the Non-volatile memory.

Yet another object of the embodiments herein provides a processor configured to return an acknowledgement to the write request.

Yet another object of the embodiments herein provides a processor configured to copy the log entry to a second portion of the metadata log and flush the data from the second portion to a SSD.

Yet another object of the embodiments herein is to provide a storage system and method for sequential writes to all metadata updates across all volumes from different hosts.

Accordingly the embodiments herein provide a method for metadata storage management. The method includes receiving a write request having a data. Further, the method includes storing the data in a log entry of a first portion of a metadata log in the Non-volatile memory. Further, the method includes returning an acknowledgement to the write request. Further, the method includes copying the log entry to a second portion of the metadata log. Further, the method includes flushing by the data from the second portion to a SSD.

In an embodiment, the first portion of the metadata log in the non-volatile memory is pointed by a logging binary tree, and the second portion of the metadata log in the Non-volatile memory pointed by a flushing binary tree.

In an embodiment, each node of the flushing binary tree comprises a list of pointers to entries in the metadata log corresponding to at least one page of a map.

In an embodiment, the each node of the logging binary tree comprises a list of pointers to entries in the metadata log corresponding to at least one page of a map.

In an embodiment, the data in the log entry of the first portion of the metadata log in the Non-volatile memory includes detecting that a key in a node is a logging binary tree is unavailable and writing the data to the log entry of the first portion of the metadata log in the Non-volatile memory.

In an embodiment, the data in the log entry of the first portion of the metadata log in the Non-volatile memory includes detecting that a key in a node in a logging binary tree is available; retrieving address of the log entry and writing the data to the log entry corresponding to the address in the first portion of the metadata log in the Non-volatile memory.

In an embodiment, the data from the second portion to the SSD includes determining whether the log entry in the Non-volatile memory points to the data in the Non-volatile memory; retrieving a Logical Block Address (LBA) corresponds to the log entry in response to determining that the log entry in the Non-volatile memory points to the data in the Non-volatile memory; detecting that a LBA page corresponding to the LBA is available in the Non-volatile memory and updating the LBA page and flushing the LBA page to the SSD.

In an embodiment, the data from the second portion to the SSD includes determining whether the log entry in the Non-volatile memory points to the data in the Non-volatile memory; retrieving a LBA corresponding to the log entry in response to determining that the log entry in the Non-volatile memory points to the data in the Non-volatile memory; detecting that a LBA page corresponding to the LBA is unavailable in the Non-volatile memory; creating and updating the LBA page. Further, flushing the LBA page to the SSD.

In an embodiment, the data from the second portion to the SSD includes determining whether the log entry in the Non-volatile memory points to the data in the Non-volatile memory; copying the log entry to a logging tree; removing the log entry from a flushing tree and postponing the flush for corresponding LBA page.

In an embodiment, the first portion includes metadata corresponding to at least one of a LBA map, a Volume table, and a Stripe Map Table.

In an embodiment, the second portion includes metadata corresponding to at least one of a metadata reverse mapping table and an Invalid page counter per-block.

Accordingly the embodiments herein provide a storage system includes a Non-volatile memory comprising a metadata log divided into a first portion and a second portion and a processor coupled to the Non-volatile memory configured to receive a write request having a data. The processor configured to store the data in a log entry of a first portion of a metadata log in the Non-volatile memory. Further, the processor configured to return an acknowledgement to the write request. Further, the processor configured to copy the log entry to the second portion of the metadata log. Further, the processor configured to flush the data from the second portion to a SSD.

Accordingly the embodiments herein provide a computer program product comprising computer executable program code recorded on a computer readable non-transitory storage medium. The computer executable program code when executed causing the actions including receiving a write request having a data. Further, the computer executable program code when executed causing the actions including storing the data in a log entry of a first portion of a metadata log in the non-volatile memory. Further, the computer executable program code when executed causing the actions including returning an acknowledgement to the write request. Further, the computer executable program code when executed causing the actions including copying the log entry to a second portion of the metadata log. Further, the computer executable program code when executed causing the actions including flushing the data from the second portion to a SSD.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Present inventive concepts are illustrated in the accompanying drawings, throughout which like reference letters indicate corresponding parts in the various figures. The embodiments herein will be better understood from the following description with reference to the drawings, in which:

FIG. 1 illustrates a block diagram representing various units of a storage system, according to an embodiment as disclosed herein;

FIG. 2 illustrates a metadata log of a Non-volatile memory for managing metadata, according to an embodiment as disclosed herein;

FIG. 3a illustrates a structure of a Non-volatile memory layout, according to an embodiment as disclosed herein;

FIG. 3b illustrates a node structure of a binary tree, according to an embodiment as disclosed herein;

FIG. 4 illustrates a volume table and a index page to a LBA, according to an embodiment as disclosed herein;

FIG. 5 illustrates a reverse map in a Non-volatile memory for metadata management, according to an embodiment as disclosed herein;

FIG. 6 is a flow diagram illustrating a storage system for metadata storage management in a Non-volatile memory, according to an embodiment as disclosed herein;

FIG. 7 is a flow diagram illustrating a method for managing a read request path for metadata management, according to an embodiment as disclosed herein;

FIG. 8 is a flow diagram illustrating a method for managing a write request path for metadata management, according to an embodiment as disclosed herein;

FIG. 9 is a flow diagram illustrating a method for managing flushing of a metadata, according to an embodiment as disclosed herein; and

FIG. 10 illustrates a computing environment implementing a storage system and method for metadata storage management, according to an embodiment as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The embodiments herein provide a storage system for managing the metadata in a Non-volatile memory. The storage system includes a metadata log divided into a first portion and a second portion and a processor coupled to the Non-volatile memory configured to receive a write request having a data. Further, the processor is configured to store the data in a log entry of a first portion of a metadata log in the Non-volatile memory. Further, the processor is configured to return an acknowledgement to the write request. Further, the processor is configured to copy the log entry to the second portion of the metadata log. Further, the processor is configured to flush (e.g., move/relocate) the data from the second portion to a SSD. Operations of the storage system (e.g., operations such as storing data, providing an acknowledgment, copying a log entry, and/or flushing data) may be referred to herein as being performed “by” the storage system, “via” the storage system, or “using” the storage system.

Unlike conventional mechanisms, the proposed storage system maintains the metadata in cache in the metadata log. Further, the proposed storage system supports sequential writes for all metadata updates across all volumes from different hosts.

Unlike conventional mechanisms, the proposed storage system performs a Garbage Collection (GC) for the metadata in the SSD(s) can maintain the SSD(s) in good state always.

Unlike the conventional mechanism, the proposed storage system provides dedicated regions for logging and flushing, thus obviating the need of locking.

Unlike the conventional mechanisms, the proposed storage system maintains some metadata permanently which may be small in size and some metadata on demand in the Non-volatile memory which is smartly flushed.

Unlike the conventional mechanisms, the proposed storage system includes managing of the metadata log by two independent binary trees ensuring no blocking of the I/O operation at any point of time because of the flushing.

Unlike the conventional mechanisms, the proposed storage system includes sending the latest update to the SSD and all other updates is overwritten in the Non-volatile memory itself to avoid multiple writes to the SSD. Thus improving the performance and endurance of the SSD.

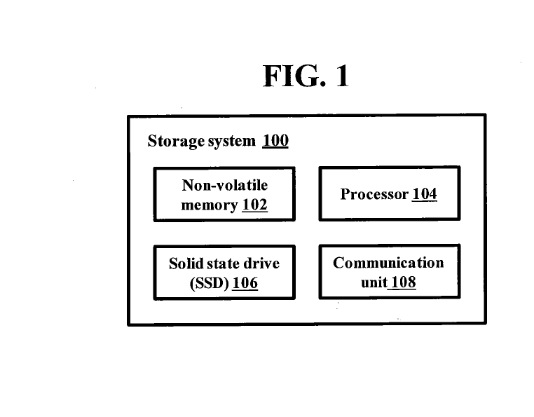

Referring now to the drawings, and more particularly to FIGS. 1 through 10, where similar reference characters denote corresponding features consistently throughout the figures, there are shown preferred embodiments.

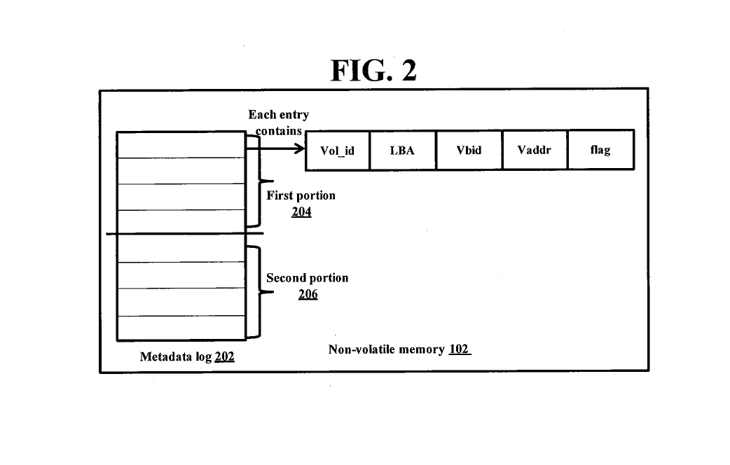

FIG. 1 illustrates a block diagram representing various units of the storage system 100, according to an embodiment as disclosed herein. The storage system 100 includes a Non-volatile memory 102, a processor 104, a SSD 106 and a communication unit 108. The Non-volatile memory 102 includes a metadata log divided into the first portion and the second portion as detailed in conjunction with FIG. 2. The processor 104 coupled to the Non-volatile memory 102 is configured to receive the write request having the data and stores the data in the log entry of the first portion of the metadata log in the Non-volatile memory 102. Further, the processor 104 is configured to return (e.g., provide/output) the acknowledgement to the write request. Further, the processor 104 configured to copy the metadata log entry to the second portion of the metadata log and flush the data from the second portion to the SSD 106. The communication unit 108 can be configured for communicating with external devices and internal devices through one or more networks.

The FIG. 1 shows exemplary units of the storage system 100 but it is to be understood that other embodiments are not limited thereon. In other embodiments, the storage system 100 may include less or more number of units. Further, the labels or names of the units are used only for illustrative purpose and does not limit the scope of the invention. One or more units can be combined together to perform same or substantially similar function in the storage system 100.

The FIG. 2 illustrates the metadata log 202 of the Non-volatile memory 102 for managing metadata, according to an embodiment as disclosed herein. The metadata log 202 of the Non-volatile memory 102 is divided into a first portion 204 and a second portion 206. The first portion 204 corresponds to a logging area and the second portion 206 corresponds to a flushing area. The first portion 204 and the second portion 206 can be interchanged alternatively. Each entry of the logging area 204 and the flushing area 206 includes a volume id (Vol_id), a Logical block address (LBA), a Virtual block id (Vbid), an offset (Vaddr) and a flag. The Vol_id is configured to determine a volume layer instance that manages volume of the metadata associated with the LBA/LBA range. The LBA address specifies a location of blocks of the data stored in the Non-volatile memory 102 and the SSD 106. The LBA is mapping to group of physical block address (Pbid) in the SSD. The Vbid and Vaddr are associated with the metadata in the Non-volatile memory 102 and in the SSD 106. Thereby, the metadata log 202 entry in the Non-volatile memory 102 is pointing to the metadata (Vbid, Vaddr) in the Non-volatile memory 102 and in the SSD 106. The flag represent, whether the metadata log 202 entry is flushed to the flushing binary tree. The flag can further aid recovering the data during Sudden Power-Off Recovery (SPOR) i.e., in case of power failures with the help of the flag state the status of the particular LBA is identified. If the LBA is pushed to the flushing binary tree that can be retrieve back to the logging area 204.

In an embodiment, the two portions area (the first portion 204 and the second portion 206) are operated by a logging thread and a flushing thread. The logging thread pushes the metadata to the logging area 204 upon receiving an update request/a write request to the particular LBA. The flushing thread flushes the updated metadata of the particular LBA from the flushing area 206 to the SSD 106. Hence, the proposed storage system 100 supports the sequential writes for all metadata updates across all volumes from different hosts.

Unlike conventional mechanisms, the proposed storage system 100 operates the two different threads on two different areas for pushing the metadata in to the logging area 204 and flushing the metadata in to the SSD 106. Thus, the proposed storage system 100 obviates the need of the locking mechanism.

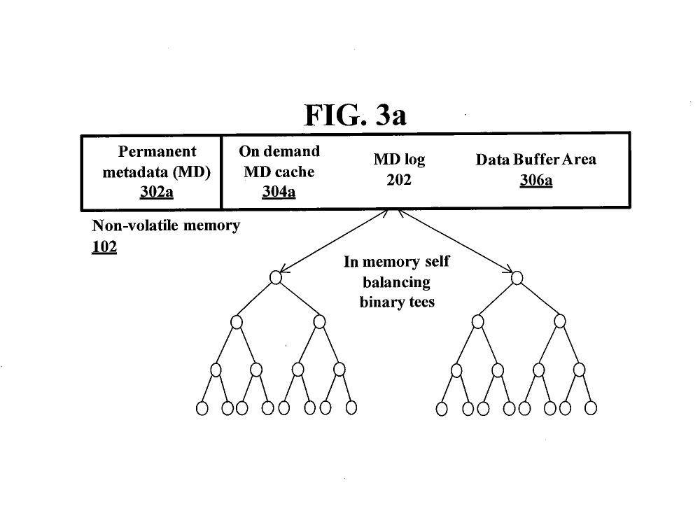

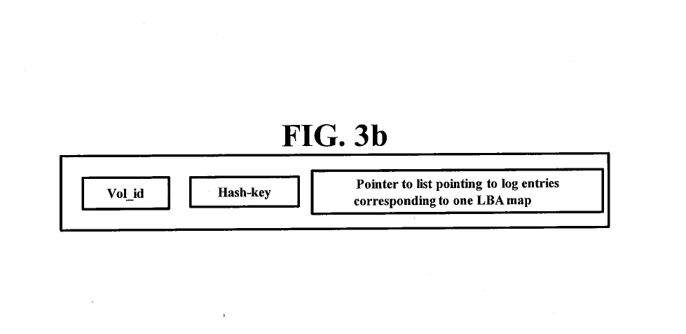

FIG. 3a illustrates a structure of the Non-volatile memory 102 layout, according to an embodiment as disclosed herein. In an embodiment, the Non-volatile memory 102 is divided into four layers such as permanent metadata (MD) 302a, on demand MD cache 304a, a metadata log 202 and a data buffer area 306a. The permanent MD 302a stores some amount of metadata permanently. The permanent MD 302a stores a stripe map table, a volume table, a MD reverse mapping table and an invalid page counter per block. In an example, if the size of the Non-volatile memory 102 is 8 GB, the Non-volatile memory 102 stores around 500 MB metadata permanently in the Non-volatile memory 102.

The Stripe map table maps the metadata data in the Non-volatile memory to the metadata in the SSD 202 (i.e., (Vbid+Vaddrs)→(Pbid+Vaddrs)). The striping of data is a technique of segmenting logically sequential data so that consecutive segments are stored on different physical storage devices such as the SSD 106 and the Non-volatile memory 102. The Volume table can have indirect indexing to the LBA map pages in the metadata log of the Non-volatile memory 102. These LBA map pages are allocated on demand thus provides locking only to a small range of mapping in case of multiple threads trying to access the volume table for fast access. The MD reverse mapping table is used for GC and for the metadata flush thread. In an example, NAND flash devices (e.g., SSDs) doesn't support in place update. Whenever there is an update to the LBA the LBA should be moved to the new location to perform the update. Further, the old memory location of the corresponding LBA is moved to the GC in order to free the memory of the NAND flash devices. The invalid page counter keeps a count for number of invalid pages in the metadata log area per block and this can used for a redundant array of inexpensive disks (RAID) level GC. Based on the invalid page counter, the metadata GC can select victim blocks thereof. In an example, when the LBA requires an update the LBA moves to the new location and can be updated. Accordingly the counter is also updated for the particular block. Hence, the old location of the particular LBA is garbage collected defining it to be the victim block.

The on demand MD cache 304a is the LBA map page for the following mapping (i.e., LBA→(Vbid+Vaddrs). The metadata pages allocated on demand and manages efficiently by the metadata log. The metadata log 202 is divided into the logging area 204 and the flushing area 206 for managing the metadata. The logging area 204 is operated by logging thread and the flushing area 206 is operated by the flushing thread. The logging thread pushes the metadata on to the logging area 204 on update or on a write request to a particular LBA; whereas the flushing thread flushes the updated metadata of a particular LBA from the flushing area 206 to the SSD 106.

The metadata log 202 is pointed to a self balancing binary tree maintained in a DRAM. The self balancing binary tree includes a logging binary tree 308a and a flushing binary tree 310a. The logging area 204 is pointed by the logging binary tree 308a and the flushing area 206 is pointed to the flushing binary tree 310a. Each node of the logging binary tree 308a and the flushing binary tree 310a includes a list of pointers to entries in the metadata log 202 corresponding to at least one page of a map, i.e., each node of the logging binary tree 308a includes a Vol_id, a hash-key, a pointer list pointing to entries in the metadata log 202 corresponding to one page of LBA map, as detailed in conjunction with FIG. 3b.

In an embodiment, when there is an update available for the particular LBA the proposed storage system 100 determines whether the vbid of the LBA is pointing to the Non-volatile memory 102. If the vbid is pointing to the Non-volatile memory 102, the method includes copying that metadata entry from the flushing area 206 to the logging area 204 thereby postponing the flush. In an embodiment, when data is flushed from the Non-volatile memory 102 to the SSD 106 the metadata log 202 may not be updated because the vbid and vaddr (offset) remains same; only the stripe map has to be changed which maps vbid 4 pbid. The data buffer area 310a of the Non-volatile memory 102 to improve the overall performance of NAND flash memory (i.e., SSD 106).

In an embodiment, the proposed method reconstructs the binary tree in case of power failures using the Metadata log 202 entries. The proposed method and storage system 100 ensures no blocking of the I/O operation at any point of time since the metadata log 202 as dedicated area for logging and flushing.

The FIG. 3b illustrates the node structure of the binary tree, according to an embodiment as disclosed herein. The binary tree includes the logging binary tree 308a and the flushing binary tree 310a. The first portion 204 of the metadata log 202 in the Non-volatile memory 102 is pointed by the logging binary tree 308a, and the second portion of the metadata log 202 in the Non-volatile memory 102 is pointed by the flushing binary tree 310a. Each node of the logging binary tree 308a and the flushing binary tree 310a includes the Vol_id, the hash-key and the pointer list pointing to entries in the metadata log corresponding to one page of the LBA map. The Key is given by Vol_id+hash_key (i.e., Key=Vol_id+hash_key), the hash_key is calculated by using LBA and the number of entries in LBA map page i.e., Hash_key=(LBA/no of entries in LBA map page). Whereas the list node consists of vol_id, LBA and pointer to Non-volatile memory 102 log entry. In an example, whenever there is an update running on to the particular LBA—all the updates related to the single LBA is performed and flushed in to the flushing tree in a single operation. This avoids overwrite and erase and improves the NAND performance and endurance by avoiding multiple writes to the SSD 106.

Unlike conventional mechanisms, the proposed storage system 100 includes the logging binary tree 308a and the flushing binary tree 310a for metadata management which can be used for flushing and logging interchanging alternatively; hence there is no blocking of input output (I/O) operations at any point of time due to the flushing operation.

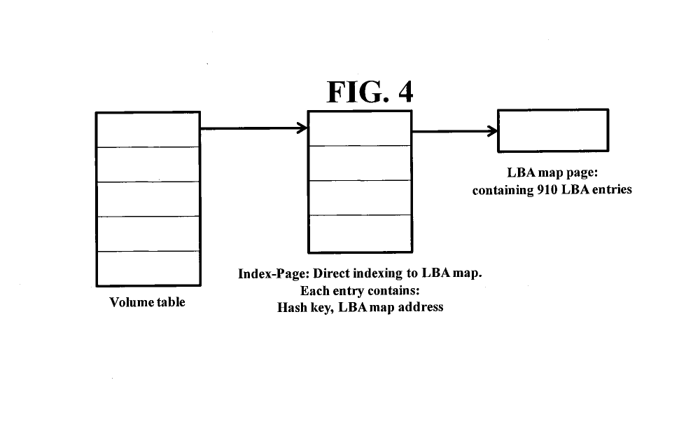

FIG. 4 illustrates the mapping of volume table and the index page to the LBA, according to an embodiment as disclosed herein. The volume table and index pages are maintained in the Non-volatile memory 102 permanently (i.e., never flushed). The volume table size is created and can only be a multiple of fixed size. Each entry in the volume table points to the corresponding index-pages which has direct indexing to entire LBA map range for that size. If the LBA is flushed the index-pages will point to the corresponding LBA map page in the Non-volatile memory 102 or to the SSD 106. Each entry of the volume table maps to fix size of LBA range in data area.

In an example, suppose fixed size is 3 GB, since each direct index-page maps to approx. 1.5 GB, so the processor 104 allocates 2 pages for index-page per volume table entry. Each entry of the volume table contains at least a Vol_id, a hash-key, index-page address. The Hash-key in the volume table is calculated by using a first LBA and range of the LBA for that volume. Similarly the hash-key in the index-page is calculated using the first LBA and the range of LBA mapped by each entry. In an embodiment, the updated LBA map will always be written to the new memory location and is tracked by a direct indexing page. This improves locking mechanism by locking only the index pages required for updating and not the entire volume table as it is acknowledging the other threads such as the flushing thread requests in a multithreading environment.

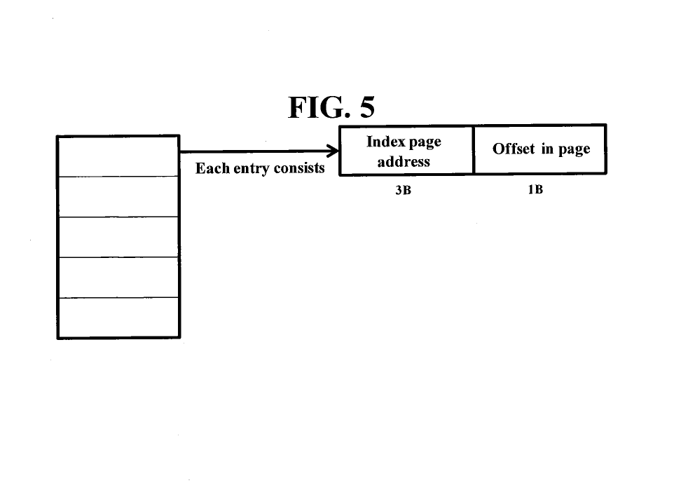

FIG. 5 illustrates the reverse map in the Non-volatile memory 102 for metadata management, according to an embodiment as disclosed herein. The reverse map is useful for the metadata GC mechanism to collect the information about the page i.e., whether the page is valid or invalid. If the page is valid GC is not performed on that page. If the page is invalid GC is performed on the invalid page to free the memory of the Non-volatile memory. Each entry of the reverse map maps on to the SSD 106 metadata address to its index page which in turn points to the corresponding LBA map.

In an example, consider 100 GB of metadata area where total number of entries to map or total number of LBA pages greater than (100 GB/4 KB)=25 metadata entries. Each entry is approximately 4 bytes; hence the total reverse map size can be at max 100 MB. The reverse map is sorted by the SSD 106 metadata area address with O (1) access. For each page address the processor 104 identifies the reverse map to get the index-page address and the offset to read the entry, if the corresponding entry of the index page points to the same address is valid otherwise it is said to be invalid.

The GC daemon selects the victim block using the invalid page counter per-block (for metadata region which can be 1 MB to 2 MB in size) and stores permanently in the Non-volatile memory 102. The reverse map table is updated each time the LBA map page is updated by increasing the invalid count of the previous block. The GC selects the block which has maximum number of invalid counter or pages. For each page in the victim block, the reverse map procedure is followed to determine whether the page is valid or invalid and further handled by the GC to erase the block to free the memory of the Non-volatile memory 102.

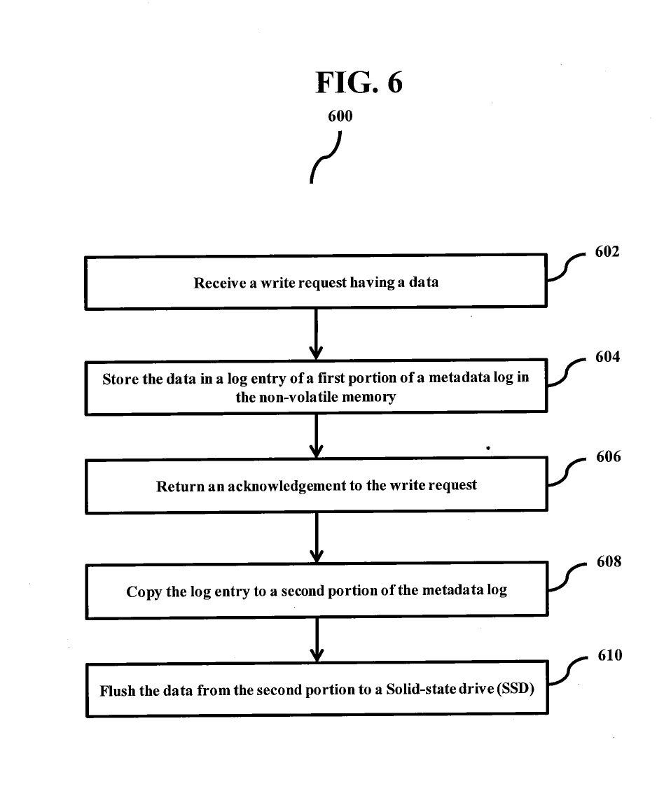

FIG. 6 is a flow diagram 600 illustrating the storage system 100 and the method for metadata storage management, according to an embodiment as disclosed herein.

At step 602, the method includes receiving the write request having a data. In an embodiment, the method allows the processor 104 to receive the write request having the data.

At step 604, the method includes storing the data in the log entry of the first portion 204 of the metadata log 202 in the Non-volatile memory 102. In an embodiment, the method allows the processor 104 to store the data in the log entry of the first portion 204 of the metadata log 202 in the Non-volatile memory 102.

At step 606, the method includes returning the acknowledgement to the write request. In an embodiment, the method allows the processor 104 to return the acknowledgement to the write request.

At step 608, the method includes copying the log entry to the second portion of the metadata log 202. In an embodiment, the method allows the processor 104 to copy the log entry to the second portion 206 of the metadata log 202.

At step 610, the method includes flushing the data from the second portion 206 to the SSD 106. In an embodiment, the method allows the processor 104 to flush the data from the second portion to the SSD 106.

The various actions, acts, blocks, steps, methods or the like in the flow diagram 600 may be performed in the order presented, in a different order or simultaneously. Further, in some embodiments, some of the actions, acts, blocks, steps, or the like may be omitted, added, modified, skipped, or the like without departing from the scope of the invention.

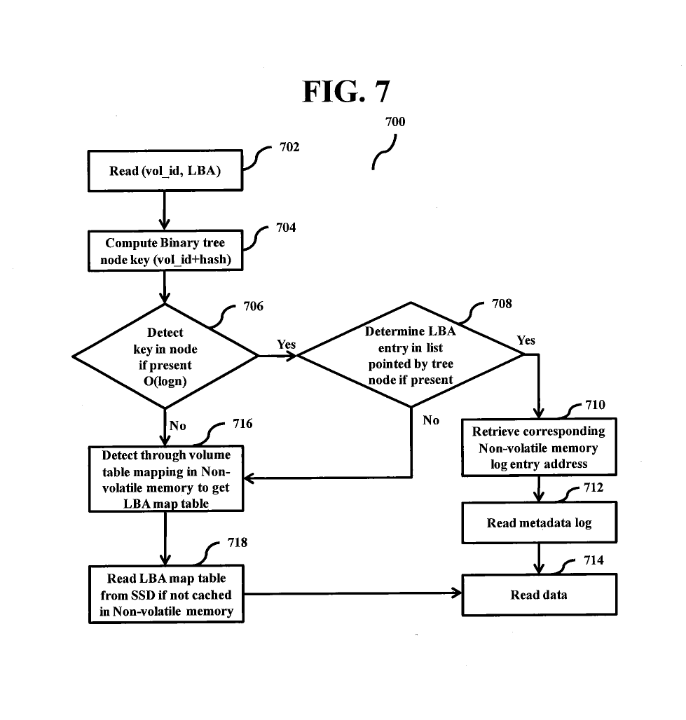

FIG. 7 is a flow diagram 700 illustrating a method for managing the read request path for metadata management, according to an embodiment as disclosed herein.

Initially, at step 702, the method includes reading Vol =id and the LBA corresponding to the metadata log 202 entry in response to determining that the metadata log 202 entry in the Non-volatile memory 102 points to the data in the Non-volatile memory 102. At step 704, the method includes computing the binary tree node key (i.e., Vol_id +hash). The hash key is calculated by using the LBA. Based on the determined hash key, at step 706, the method includes detecting the key in the node of the logging binary tree 308a. If the method detects that the key is present in the node of the logging binary tree 308a, and then at step 708, the method includes determining for the LBA entry in the list pointed by the logging binary tree 308a node. If the LBA entry is present in the list pointed by the logging binary tree 308a node, at step 710, the method includes retrieving the corresponding metadata log 202 entry addresses in the Non-volatile memory 102. At step 712, the method includes reading the metadata log 202 corresponding to the metadata log 202 entry address in the Non-volatile memory 102. At step 714, the method includes reading the latest metadata from the metadata log 202 corresponding to the metadata log 202 entry address. At step 706, the method includes detects that the key in the node of the logging binary tree 308a. If the method detects that the key is not present in the node of the logging binary tree 308a, then at step 716, the method includes detecting through the volume table mapping in the Non-volatile memory 102 to get LBA mapping table. At step 718, the method includes reading the LBA mapping table from the SSD 106, if not cached in the Non-volatile memory 102. At step 714, the method includes reading the metadata from the SSD 106 corresponding to the LBA mapping table.

In an embodiment, the read request path to manage the metadata can be given in the following steps:

### 1. Read (Vol_id, LBA);

LBA→(Vbid+Vaddrs)

2. Calculate the hash key using the LBA
3. Check in logging binary tree 308a
4. If entry present in the logging binary tree 308a then read the entry from the log to get the latest metadata, else search though Vol_table to get the mapping of data.

In an embodiment, the above mentioned methods of the various steps in the flow diagram 700 are performed through the processor 104.

The various actions, acts, blocks, steps, method or the like in the flow diagram 700 may be performed in the order presented, in a different order or simultaneously. Further, in some embodiments, some of the actions, acts, blocks, steps, or the like may be omitted, added, modified, skipped, or the like without departing from the scope of the invention.

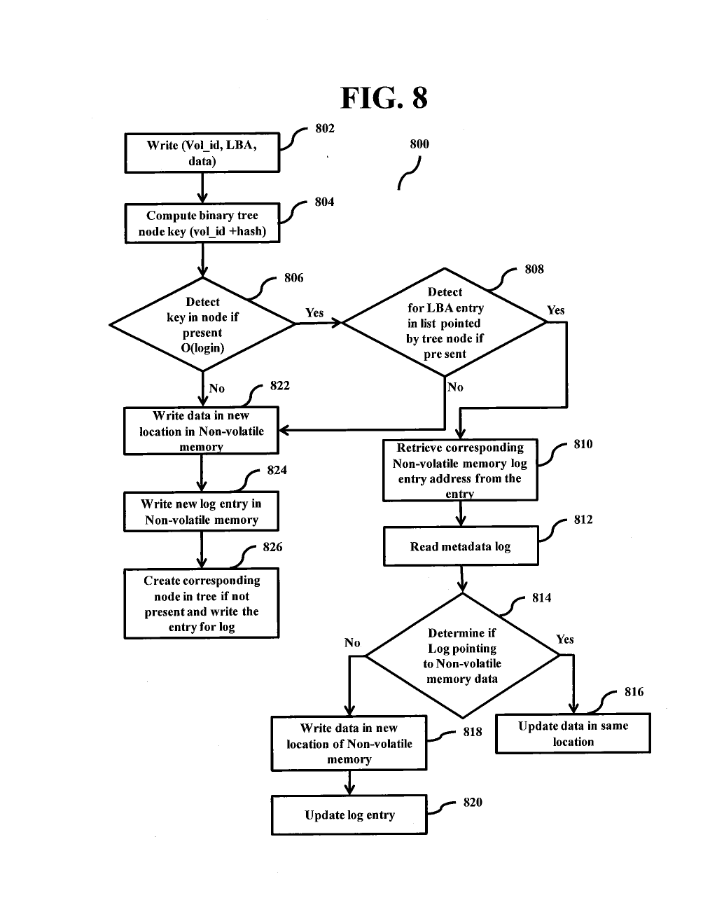

FIG. 8 is a flow diagram 800 illustrating the method for managing the write request path for metadata management, according to an embodiment as disclosed herein.

Initially at step 802, the method includes writing (i.e, write) the Vol_id and the LBA corresponding to the metadata log 202 entry in response to determining that the log entry in the Non-volatile memory 102 points to the data Non-volatile memory 102. At step 804, the method includes computing the binary tree node key (i.e., vol_id+hash). The hash key is calculated using the LBA. At step 806, the method includes detecting the key in the node of the logging binary tree 308a. If the processor 104 detects that the key is present in the node of the logging binary tree 308a, then at step 808, the method includes detecting the LBA entry in list pointed by the logging binary tree 308a node. If the LBA entry is present in the list pointed by the logging binary tree 308a node, then at step 810, the method includes retrieving the corresponding metadata log 202 entry address in the Non-volatile memory 102. At step 812, the method includes reading the metadata log 202 corresponding to the metadata log 202 entry address in the Non-volatile memory 102. At step 814, the method includes determining whether the metadata log 202 entry is pointing to the Non-volatile memory 102 data (i.e., vbid, vaddr) in the Non-volatile memory 102. If the processor 104 determines that the metadata log 202 entry is pointing to the Non-volatile memory 102 data, then at step 816, the method includes updating the data in the same location. At step 814, the method allows the processor 104 to determine that the log entry is not pointing to the Non-volatile memory 102 data in the Non-volatile memory 102, then at step 818, the method includes writing the data in to the new memory location of the Non-volatile memory 102. At step 820, the method includes updating the metadata log 202 entry corresponding to the write data in the metadata log 202 entry is pointing to the Non-volatile memory 102 data (i.e., vbid, vaddr) in the Non-volatile memory 102. At step 806, the method includes detecting the key in the node of the logging binary tree 308a is not available then at step 822, the method includes writing the data in to the new memory location in the Non-volatile memory 102 and then writes the new metadata log 202 entry to the Non-volatile memory at step 824. At step 826, the method includes creating the corresponding node in the logging binary tree 308a and writes the entry to the log.

In an embodiment, the write request path to manage the metadata can be given in the following steps:

Write (vol_id, LBA, write)

Calculate Hash key from LBA.
If the entry exist in binary tree

The log entry in Non-volatile memory 102 is pointing to the data (i.e., vbid, vaddr) in the Non-volatile memory 102—update the data in Non-volatile memory 102 in place and no need to change the log entry. If log is in flushing binary tree 310a then copy the node entry to the logging binary tree 308a.

The log entry in Non-volatile memory 102 is pointing to the data (vbid, vaddr) in the SSD 106, write the data in the Non-volatile memory 102 to the new location and update the log entry to point to the new location. If log is in flushing binary tree 310a make the new entry to logging binary tree 308a with the updated location.

Determining that the entry does not exist in binary tree; Check the Vol_table for (Vol_id, LBA).

If entry is in Vol_table and if the entry is pointing to the Non-volatile memory 102—update the data in the Non-volatile memory 102 in place and make the entry in the logging binary tree 308a.

If the entry pointing to the SSD 106—write the data in Non-volatile memory 102 in the new location and make the entry in the logging binary tree 308a.

If entry is not in Vol_table then write the data in the Non-volatile memory 102 in the new location and make the entry in the logging binary tree 308a.

In an embodiment, the above mentioned methods of the various steps in the flow diagram 800 are performed through the processor 104.

The various actions, acts, blocks, steps, method or the like in the flow diagram 800 may be performed in the order presented, in a different order or simultaneously. Further, in some embodiments, some of the actions, acts, blocks, steps, or the like may be omitted, added, modified, skipped, or the like without departing from the scope of the invention.

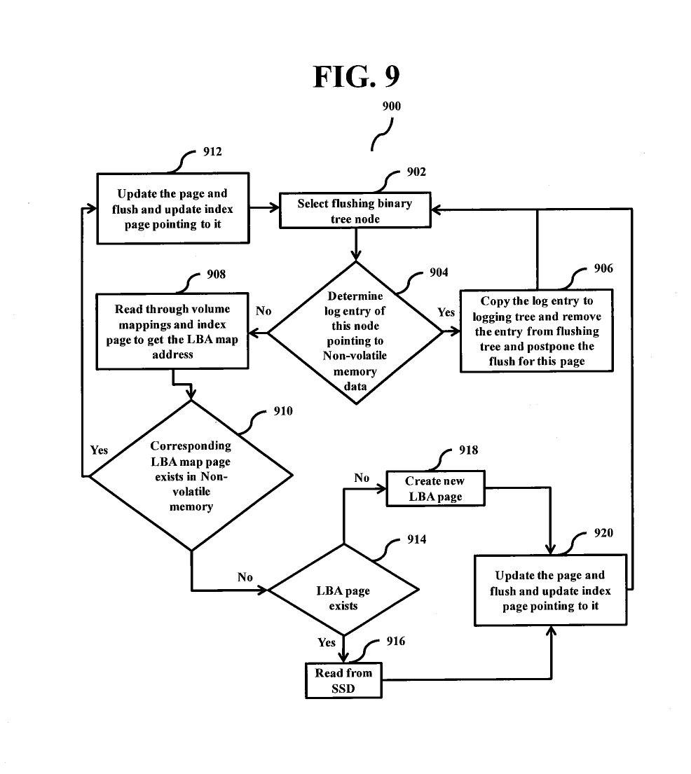

FIG. 9 is a flow diagram 900 illustrating the method for managing flushing of the data for metadata management, according to an embodiment as disclosed herein.

At step 902, the method includes selecting the flushing binary tree 310a node. At step 904, the method includes determining whether the metadata log 202 entry in the Non-volatile memory 102 points to the data in the Non-volatile memory 102. If the method, at step 904, determines that the metadata log 202 entry in the Non-volatile memory 102 is pointing to the data in the Non-volatile memory 102, then at step 906 the method includes copying the metadata log 202 entry in to the logging binary tree 308a and remove the metadata log 202 entry from the flushing binary tree 310a and postpone the flushing for the page. At step 904, if the determines that the metadata log 202 entry is not pointing the data in the Non-volatile memory 102, then at step 908, the method includes reading through the volume mappings and index page to get the LBA map address. At step 910, the method includes detecting for the corresponding LBA map page in the Non-volatile memory 102, if the LBA map is exist in the Non-volatile memory 102, then at step 912, the method includes updating the LBA page and flushing the LBA page to the SSD 106 and further update the index page pointing to the LBA page. At step 910, if the method detects that the corresponding LBA map page is not exists in the Non-volatile memory 102, and then at step 914, the method includes detecting the LBA page. If the LBA page is detected at step 914, then at step 916 the method includes reading the data from the SSD 106 and updates the LBA page and flush. Further update the index page pointing to the LBA page at step 920. At step 914, the method includes determining that the LBA page is not available in the Non-volatile memory 102, and then at step 918 the method includes creating the new LBA page. At step 920, the method includes updating the LBA page and flushes the LBA page to the SSD 106.

In an embodiment, the flushing of metadata can be performed for managing the metadata, the process of flushing involves flushing all entries in the binary tree, which includes two cases as detailed below:

1. Data present in the Non-volatile memory 102: In this case just postpone the flush; copy the corresponding log entry to logging binary tree 308a and the LBA map page is not updated for the same.
2. Data present in the SSD 106: Corresponding metadata map is already present in the Non-volatile memory 102; Update the corresponding entry in the index page and flush the particular LBA map page to the SSD 106 and update the reverse map.
3. Corresponding metadata map not present in the Non-volatile memory 102: bring the corresponding map page to Non-volatile memory 102 and update. Else (i.e., if this is the first time write) prepare the map page flush and update the index page.

Unlike the conventional mechanisms, the proposed storage system 100 and method performs group flushing; where all the LBA related to particular page is flushed in single operation.

In an embodiment, the above mentioned methods of the various steps in the flow diagram 900 are performed through the processor 104.

The various actions, acts, blocks, steps, or the like in the flow diagram 900 may be performed in the order presented, in a different order or simultaneously. Further, in some embodiments, some of the actions, acts, blocks, steps, or the like may be omitted, added, modified, skipped, or the like without departing from the scope of the invention.

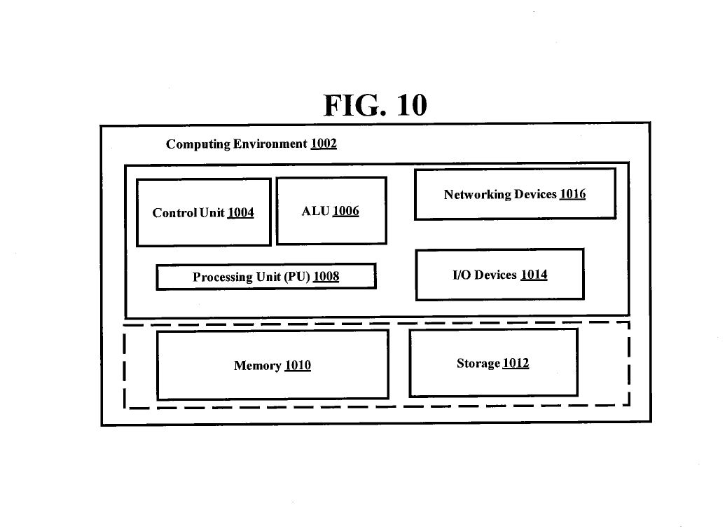

FIG. 10 illustrates a computing environment implementing the method for metadata storage management, according to an embodiment as disclosed herein. As depicted the computing environment 1002 comprises at least one processing unit 1008 that is equipped with a control unit 1004 and an Arithmetic Logic Unit (ALU) 1006, a memory 1010, a storage unit 1012, plurality of networking devices 1016 and a plurality Input output (I/O) devices 1014. The processing unit 1008 is responsible for processing the instructions of the algorithm. The processing unit 1008 receives commands from the control unit 1008 in order to perform its processing. Further, any logical and arithmetic operations involved in the execution of the instructions are computed with the help of the ALU 1006.

The embodiments disclosed herein can be implemented through at least one software program running on at least one hardware device and performing network management functions to control the elements. The elements shown in FIGS. 1 and 10 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for metadata storage management, the method comprising:
receiving, at a storage system, a write request comprising data;
storing, via the storage system, the data in a log entry of a first portion of a metadata log in a non-volatile memory;
providing, via the storage system, an acknowledgement to the write request;
copying, via the storage system, the log entry to a second portion of the metadata log; and
flushing, via the storage system, the data from the second portion to a solid-state drive (SSD).

2. The method of claim 1, wherein the first portion of the metadata log in the non-volatile memory is pointed by a logging binary tree, and wherein the second portion of the metadata log in the non-volatile memory is pointed by a flushing binary tree.

3. The method of claim 2, wherein each node of the flushing binary tree comprises a list of pointers to entries in the metadata log corresponding to at least one page of a map.

4. The method of claim 2, wherein each node of the logging binary tree comprises a list of pointers to entries in the metadata log corresponding to at least one page of a map.

5. The method of claim 1, wherein storing, via the storage system, the data in the log entry of the first portion of the metadata log in the non-volatile memory comprises:
detecting that a key in a node in a logging binary tree is unavailable; and
writing the data to the log entry of the first portion of the metadata log in the non-volatile memory.

6. The method of claim 1, wherein storing, via the storage system, the data in the log entry of the first portion of the metadata log in the non-volatile memory comprises:
detecting that a key in a node in a logging binary tree is available;
retrieving an address of the log entry; and
writing the data to the log entry corresponding to the address in the first portion of the metadata log in the non-volatile memory.

7. The method of claim 1, wherein flushing, via the storage system, the data from the second portion to the SSD comprises:
determining whether the log entry in the non-volatile memory points to the data in the non-volatile memory;
retrieving a logical block address (LBA) corresponding to the log entry in response to determining that the log entry in the non-volatile memory points to the data in the non-volatile memory;
detecting that a LBA page corresponding to the LBA is available in the non-volatile memory; and
updating the LBA page and flushing the LBA page to the SSD.

8. The method of claim 1, wherein flushing, via the storage system, the data from the second portion to the SSD comprises:
determining whether the log entry in the non-volatile memory points to the data in the non-volatile memory;
retrieving a logical block address (LBA) corresponding to the log entry in response to determining that the log entry in the non-volatile memory points to the data in the non-volatile memory;
detecting that a LBA page corresponding to the LBA is unavailable in the non-volatile memory;
creating and updating the LBA page; and
flushing the LBA page to the SSD.

9. The method of claim 1, wherein flushing, via the storage system, the data from the second portion to the SSD comprises:
determining whether the log entry in the non-volatile memory points to the data in the non-volatile memory;
copying the log entry to a logging tree;
removing the log entry from a flushing tree; and
postponing the flush for a corresponding logical block address (LBA) page.

10. The method of claim 1, wherein the second portion comprises metadata corresponding to at least one of a metadata reverse mapping table and an invalid page counter per-block.

11. A storage system comprising:
a non-volatile memory comprising a metadata log comprising a first portion and a second portion; and
a processor, coupled to the non-volatile memory, configured to:
receive a write request comprising data;
store the data in a log entry of the first portion of the metadata log in the non-volatile memory;
provide an acknowledgement to the write request;
copy the log entry to the second portion of the metadata log; and
flush the data from the second portion to a solid-state drive (SSD).

12. The storage system of claim 11, wherein the first portion of the metadata log in the non-volatile memory is pointed by a logging binary tree, and wherein the second portion of the metadata log in the non-volatile memory is pointed by a flushing binary tree.

13. The storage system of claim 12, wherein each node of the flushing binary tree comprises a list of pointers to entries in the metadata log corresponding to at least one page of a map.

14. The storage system of claim 12, wherein each node of the logging binary tree comprises a list of pointers to entries in the metadata log corresponding to at least one page of a map.

15. The storage system of claim 11, wherein the storage system is configured to store the data in the log entry of the first portion of the metadata log in the non-volatile memory by:
detecting that a key in a node in a logging binary tree is unavailable; and
writing the data to the log entry of the first portion of the metadata log in the non-volatile memory.

16. The storage system of claim 11, wherein the storage system is configured to store the data in the log entry of the first portion of the metadata log in the non-volatile memory by:
detecting that a key in a node in a logging binary tree is available;
retrieving an address of the log entry; and
writing the data to the log entry corresponding to the address in the first portion of the metadata log in the volatile memory.

17. The storage system of claim 11, wherein the storage system is configured to flush the data from the second portion to the SSD by:
determining whether the log entry in the non-volatile memory points to the data in the non-volatile memory;
retrieving a logical block address (LBA) corresponding to the log entry in response to determining that the log entry in the non-volatile memory points to the data in the non-volatile memory;
detecting that a LBA page corresponding to the LBA is available in the non-volatile memory; and
updating the LBA page and flushing the LBA page to the SSD.

18. The storage system of claim 11, wherein the storage system is configured to flush the data from the second portion to the SSD by:
determining whether the log entry in the non-volatile memory points to the data in the non-volatile memory;
retrieving a logical block address (LBA) corresponding to the log entry in response to determining that the log entry in the non-volatile memory points to the data in the non-volatile memory;
detecting that a LBA page corresponding to the LBA is unavailable in the non-volatile memory;
creating and updating the LBA page; and
flushing the LBA page to the SSD.

19. The storage system of claim 11, wherein the storage system is configured to flush the data from the second portion to the SSD by:
determining whether the log entry in the non-volatile memory points to the data in the non-volatile memory;
copying the log entry to a logging tree;
removing the log entry from a flushing tree; and
postponing the flush for a corresponding a logical block address (LBA) page.

20. A computer program product comprising computer executable program code recorded on a computer readable non-transitory storage medium, said computer executable program code when executed causing the actions including:
receiving, at a storage system, a write request having a data;
storing, via the storage system, the data in a log entry of a first portion of a metadata log in a non-volatile memory;
providing, via the storage system, an acknowledgement to the write request;
copying, via the storage system, the log entry to a second portion of the metadata log; and
flushing, via the storage system, the data from the second portion to a solid-state drive (SSD).
